(19) United States
(12) Patent Application Publication
(10) Pub. No.: US 2025/0341888 A1
(43) Pub. Date: Nov. 6, 2025

(54) ELECTRONIC DEVICE FOR OUTPUTTING NOTIFICATION INFORMATION, AND OPERATION METHOD THEREOF

(71) Applicant: Samsung Electronics Co., Ltd., Suwon-si (KR)

(72) Inventors: Jaehyuk CHOI, Suwon-si (KR); Wonhee Lee, Suwon-si (KR)

(73) Assignee: Samsung Electronics Co., Ltd., Suwon-si (KR)

(21) Appl. No.: 19/267,071

(22) Filed: Jul. 11, 2025

Related U.S. Application Data
(63) Continuation of application No. PCT/KR2023/021329, filed on Dec. 21, 2023.

(30) Foreign Application Priority Data
Jan. 13, 2023 (KR) 10-2023-0005611
Feb. 13, 2023 (KR) 10-2023-0018959

(51) Int. Cl. G06F 3/01

(52) U.S. Cl. CPC G06F 3/012

(57) ABSTRACT

An electronic device includes: a communication circuitry; a sensor; an output device; at least one processor; and memory storing instructions, wherein the instructions, when executed by the at least one processor individually or collectively, cause the electronic device to: perform calibration for sensing a change in a tilt angle of a head of a user wearing a wearable electronic device; determine a number of steps of the user and a first sensing value indicating an angular change of the electronic device via the sensor after performing the calibration; receive, via the communication circuitry, a second sensing value indicating the change in the tilt angle of the head of the user identified by the wearable electronic device; and output notification information, via the output device, based on the number of steps of the user, the first sensing value, and the second sensing value satisfying specified conditions.

### CROSS-REFERENCE TO RELATED APPLICATIONS

This application is a continuation application of International Application No. PCT/KR2023/021329 filed on Dec. 21, 2023, which claims priority to Korean Patent Application No. 10-2023-0005611, filed on Jan. 13, 2023, in the Korean Intellectual Property Office, and Korean Patent Application No. 10-2023-0018959, filed on Feb. 13, 2023, in the Korean Intellectual Property Office, the disclosures of which are incorporated by reference herein in their entireties.

### BACKGROUND

### 1. Field

The disclosure relates to an electronic device for outputting notification information and a method for operating the same.

### 2. Description of Related Art

As the use of smartphones increases in modern life, situations where users walk while looking down at their smartphones have become more common. As a result, there has been an increase in musculoskeletal disorders around the users' necks and the occurrence of accidents.

An electronic device may include a function capable of detecting a condition in which a user's safety is at risk. Accordingly, the electronic device may output notification information when detecting the condition in which the user is at risk.

### SUMMARY

According to an aspect of the disclose, an electronic device includes: a communication circuitry; a sensor; an output device; at least one processor; and memory storing instructions, wherein the instructions, when executed by the at least one processor individually or collectively, cause the electronic device to: perform calibration for sensing a change in a tilt angle of a head of a user wearing a wearable electronic device; determine a number of steps of the user and a first sensing value indicating an angular change of the electronic device via the sensor after performing the calibration; receive, via the communication circuitry, a second sensing value indicating the change in the tilt angle of the head of the user identified by the wearable electronic device; and output notification information, via the output device, based on the number of steps of the user, the first sensing value, and the second sensing value satisfying specified conditions.

According to an aspect of the disclosure, a method includes: performing calibration for sensing a change in a tilt angle of a head of a user wearing a wearable electronic device; determining a number of steps of the user and a first sensing value indicating an angular change of an electronic device via a sensor included in the electronic device after performing the calibration; receiving, via a communication circuitry included in the electronic device, a second sensing value indicating the change in the tilt angle of the head of the user identified by the wearable electronic device; and outputting notification information via an output device included in the electronic device based on the number of steps of the user, the first sensing value, and the second sensing value satisfying specified conditions.

According to an aspect of the disclosure, a non-transitory storage medium storing computer-readable instructions, wherein the instructions, when executed by at least one processor of an electronic device, individually or collectively, causes the electronic device to: perform calibration for sensing a change in a tilt angle of the head of a user wearing a wearable electronic device; determine a number of steps of the user and a first sensing value indicating an angular change of the electronic device via a sensor included in the electronic device after performing the calibration; receive, via a communication circuitry included in the electronic device, a second sensing value indicating the change in the tilt angle of the head of the user identified by the wearable electronic device; and output notification information via an output device included in the electronic device based on the number of steps of the user, the first sensing value, and the second sensing value satisfying specified conditions.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a block diagram of an electronic device in a network environment according to one or more embodiments;

FIG. 2A illustrates a state in which an electronic device according to one or more embodiments identifies a change in the tilt angle of a user's head and a change in the tilt angle of the electronic device and outputs notification information;

FIG. 2B illustrates a system that outputs notification information based on the angular change of an electronic device according to one or more embodiments and the angular change of a user's head;

FIG. 2C is a schematic block diagram of a wearable electronic device according to one or more embodiments;

FIG. 3 is a flowchart illustrating a method for operating an electronic device according to one or more embodiments;

FIG. 4 is a flowchart illustrating a method for operating an electronic device according to one or more embodiments;

FIG. 5A is a flowchart illustrating an operation method for performing calibration by an electronic device according to one or more embodiments;

FIG. 5B illustrates a screen displayed on a display when an electronic device according to one or more embodiments performs calibration;

FIG. 5C illustrates a screen displayed on a display when an electronic device according to an embodiment performs calibration;

FIG. 5D illustrates a screen displayed on a display when an electronic device according to one or more embodiments performs calibration;

FIG. 6A illustrates roll, pitch, and yaw data according to one or more embodiments;

FIG. 6B illustrates an operation of performing calibration by an electronic device according to one or more embodiments;

FIG. 7 is a flowchart showing a method for operating an electronic device operates according to one or more embodiments;

FIG. 8A is a graph showing sensing values indicating angular changes of an electronic device according to one or more embodiments;

FIG. 8B is a graph showing sensing values indicating angular changes of a user's head according to one or more embodiments;

FIG. 9A illustrates an operation in which an electronic device according to one or more embodiments identifies that a user is not in a smartphone zombie state and is walking while wearing the electronic device on the user's arm;

FIG. 9B is a flowchart illustrating a method for operating an electronic device according to one or more embodiments, wherein the electronic device identifies that a user is exercising while wearing the electronic device on the arm; and

FIG. 9C is a graph showing a sensing value indicating the angular change of an electronic device and a sensing value indicating the angular change of a user's head while the user is wearing the electronic device on the arm according to one or more embodiments.

### DETAILED DESCRIPTION

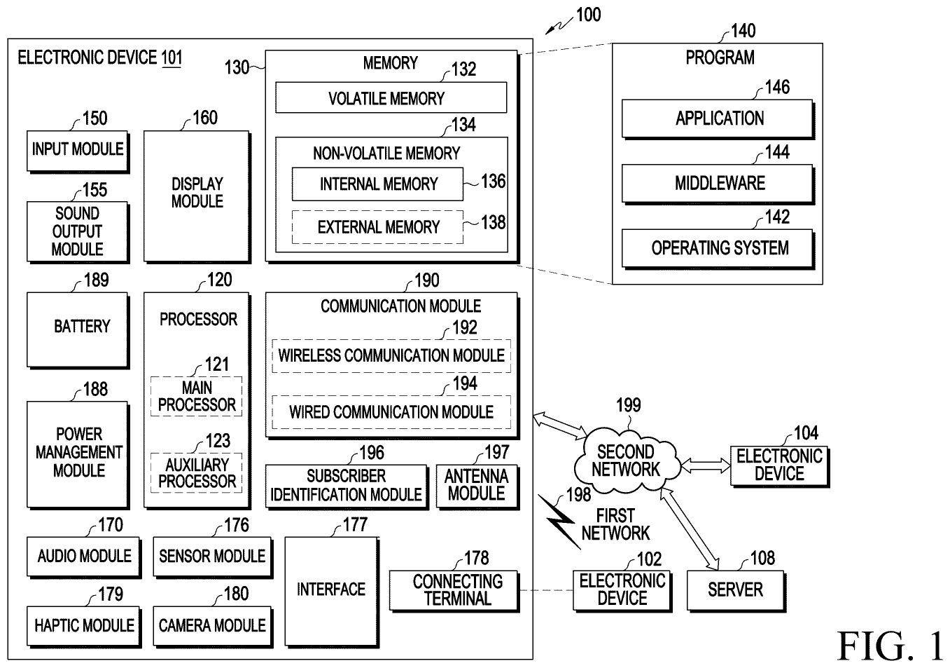

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

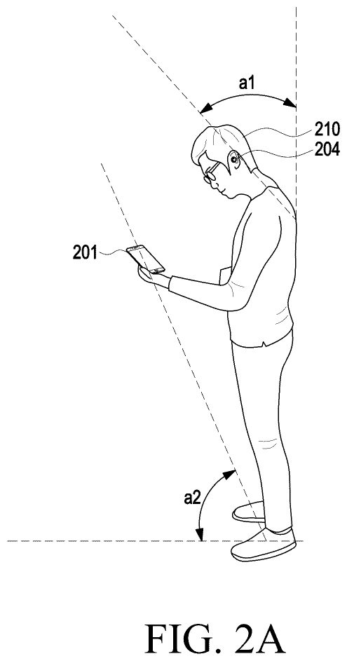

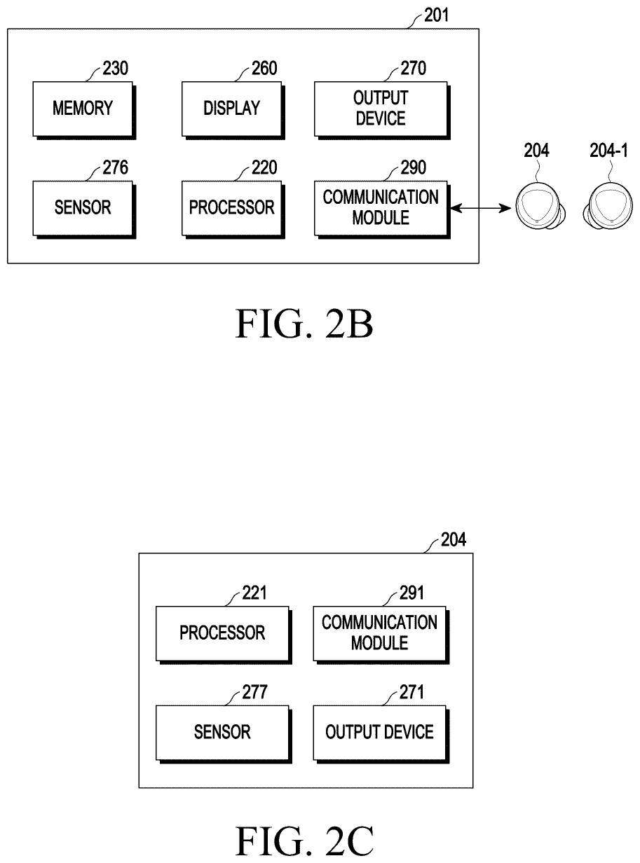

FIG. 2A illustrates a state in which an electronic device according to an embodiment identifies a change in the tilt angle of a user's head and a change in the tilt angle of the electronic device and outputs notification information.

Referring to FIG. 2A, according to an embodiment, an electronic device 201 may establish a communication connection with a wearable electronic device 204. For example, the electronic device 201 may be implemented identically or similarly to the electronic device 101 in FIG. 1. According to an embodiment, the electronic device 201 may be implemented as a smartphone.

According to an embodiment, the wearable electronic device 204 may be worn by a user. According to an embodiment, the wearable electronic device 204 may be implemented as a wearable electronic device that can be worn on the user's ear.

According to an embodiment, the electronic device 201 may identify whether the user is in a smartphone zombie (smombie) state. The electronic device 201 may identify whether the user is in a smombie state, based on information sensed by a sensor included in the electronic device 201 and a sensor included in the wearable electronic device 204. The electronic device 201 may output notification information when the user is identified to be in a smombie state. For example, the notification information may be provided via a visual means (e.g., displaying a pop-up window), an auditory means (e.g., outputting sound), and/or a tactile means (e.g., outputting vibration). For example, the electronic device 201 may output notification information, based on a change in the tilt angle of the user's head and a change in the tilt angle of electronic device 201.

According to an embodiment, the electronic device 201 may perform calibration to establish a criterion for a change in the tilt angle of a user's head. The tilt angles of users' heads may be different from one another. Also, even when a user is looking straight ahead, the user's head may still be slightly tilted. If calibration is not performed, the electronic device 201 may not accurately identify that the user's head is tilted. That is, the electronic device 201 may not accurately identify that the user is in a smombie state. Accordingly, the electronic device 201 according to various embodiments of the disclosure may perform calibration to establish a criterion for a change in the tilt angle of the user's head in order to identify whether the user is in a smombie state.

According to an embodiment, when the user is looking straight ahead without any movement of the user's head, the electronic device 201 may identify a first sensing value sensed by the wearable electronic device 204. According to an embodiment, the electronic device 201 may identify multiple second sensing values sensed by the wearable electronic device 204 when the user's head is in a maximally downward-tilted posture and when the user's head is in a maximally upward-tilted posture. According to an embodiment, the electronic device 201 may perform calibration based on the first sensing value and the multiple second sensing values. For example, the electronic device 201 may identify, based on the first sensing value, whether the user's head is tilted. Furthermore, the electronic device 201 may identify, based on the first sensing value, an angle of the user's head when the user's head is maximally tilted upward and an angle of the user's head when the user's head is maximally tilted downward. Based on the identified angles, the electronic device 201 may identify whether the user's head is tilted.

According to an embodiment, the electronic device 201 may identify a sensing value indicating an angular change a1 of the user's head 210 identified by the wearable electronic device 204. For example, the angular change a1 of the user's head 210 may indicate an angle at which the user's head 210 is tilted relative to the first sensing value when the user is looking straight ahead without any movement of the user's head.

According to an embodiment, the electronic device 201 may identify the number of a user's steps and a sensing value indicating an angular change a2 of the electronic device 201. For example, the number of the user's steps may include the number of the user's steps for a predetermined time, and a movement state (e.g., walking state) of the user may be identified based on the number of the user's steps. For example, the angular change a2 of the electronic device 201 may indicate an angle at which the electronic device 201 is tilted relative to the horizontal.

According to an embodiment, the electronic device 201 may identify whether the screen of a display (e.g., the display module 160 in FIG. 1) is in turned on. For example, when the user's head is identified to be in a tilted state, the electronic device 201 may identify whether the screen of the display is turned on. Based on the identification result, the electronic device 201 may identify whether the user is in a smombie state.

According to an embodiment, the electronic device 201 may output notification information indicating that the user is in a smombie state, when it is identified that the number of the user's steps is greater than a first threshold value, the angular change a2 of the electronic device 201 is greater than a second threshold value (e.g., 30 degrees), the angular change a1 of the head 210 of the user wearing the wearable electronic device 204 is greater than a third threshold value (e.g., 30 degrees), and the screen of the display is turned on. For example, the smombie state may indicate that the user is walking with the head tilted downward to view the electronic device 201 (e.g., a smartphone).

According to an embodiment, the electronic device 201 may transmit, to the wearable electronic device 204, the notification information indicating that the user is in the smombie state. According to an embodiment, the wearable electronic device 204 may output the notification information indicating that the user is in the smombie state. For example, the wearable electronic device 204 may output the notification information as a voice and/or vibration.

FIG. 2B illustrates a system for outputting notification information, based on an angular change of an electronic device and an angular change of a user's head according to an embodiment. FIG. 2C is a schematic block diagram of a wearable electronic device according to an embodiment.

Referring to FIG. 2B, according to an embodiment, an electronic device 201 (e.g., the electronic device 101 in FIG. 1) may include memory 230 (e.g., the memory 130 in FIG. 1), a sensor 276 (e.g., the sensor 176 in FIG. 1), a processor 220 (e.g., the processor 120 in FIG. 1), a display 260 (e.g., the display module 160 in FIG. 1), an output device 270 (e.g., the acoustic output module 155 in FIG. 1), and a communication module or communication circuitry 290 (e.g., the communication module 190 in FIG. 1).

According to an embodiment, the electronic device 201 may be implemented identically or similarly to the electronic device 101 in FIG. 1. According to an embodiment, the electronic device 201 may be implemented as a smartphone.

According to an embodiment, wearable electronic devices 204 and 204-1 may be implemented as wearable electronic devices that can be worn on a user's ear. Referring now to FIG. 2C, a schematic block diagram of the wearable electronic device 204 is shown. According to an embodiment, the wearable electronic device 204 may include a processor 221, a sensor 277, a communication module 291, and an output device 271. According to an embodiment, the wearable electronic device 204-1 may include a processor, a sensor, a communication module, and an output device. In the following, the wearable electronic device 204 is described as performing an operation.

According to an embodiment, the processor 220 may control the overall operation of the electronic device 201. For example, the processor 220 may be implemented identically or similarly to the processor 120 in FIG. 1.

According to an embodiment, the processor 220 may establish a communication connection between the electronic device 201 and the wearable electronic device 204 via the communication module 290.

According to an embodiment, the processor 220 may identify whether the user is in a smombie state. The processor 220 may identify whether the user is in a smombie state, based on information sensed by the sensor 276 and information sensed by the sensor included in the wearable electronic device 204. When it is identified that the user is in a smombie state, the processor 220 may output notification information via the display 260 and/or the output device 270. For example, the electronic device 201 may output notification information, based on a change in the tilt angle of the user's head and a change in the tilt angle of the electronic device 201.

According to an embodiment, the processor 220 may perform calibration for sensing a change in the tilt angle of the head of a user wearing the wearable electronic device 204. According to an embodiment, the processor 220 may perform the calibration to establish a criterion for the change in the tilt angle of the user's head.

According to an embodiment, the processor 220 may transmit information indicating the start of a calibration operation to the wearable electronic device 204 via the communication module 290. According to an embodiment, the information indicating the start of the calibration operation may include notification information that causes the user wearing the wearable electronic device 204 to maintain a specified posture (e.g., a posture in which the user is looking straight ahead without head movement) for a predetermined time. According to an embodiment, the wearable electronic device 204 may identify, based on multiple sensing values obtained over a predetermined time, whether the user maintains the specified posture for the predetermined time (e.g., 10 seconds). According to an embodiment, the specified posture may include a posture in which the user is looking straight ahead without any movement of the user's head. For example, when the multiple sensing values obtained over the predetermined time via the sensor 277 are equal to each other, or when the difference between the multiple sensing values is within a predetermined range, the wearable electronic device 204 may identify that the user maintains the specified posture for the predetermined time. According to an embodiment, when the user is identified to maintain the specified posture for the predetermined time, the wearable electronic device 204 may transmit a sensing value included in the multiple sensing values to the electronic device 201 via the communication module 291. In some embodiments, the sensing value may be an average value of the multiple sensing values.

According to an embodiment, the processor 220 may receive a sensing value, which is identified to be sensed when the user's head is in a specified posture, from the wearable electronic device 204 via the communication module 290. According to an embodiment, the sensing value may include at least one of roll data or pitch data.

According to an embodiment, the processor 220 may receive multiple sensing values, sensed when the user's head is in multiple postures different from the specified posture, from the wearable electronic device 204 via the communication module 290. According to an embodiment, the multiple postures different from the specified posture may include a posture in which the user's head is maximally tilted downward and a posture in which the user's head is maximally tilted upward. According to an embodiment, the multiple sensing values may include at least one of roll data, pitch data, or yaw data sensed in the multiple postures.

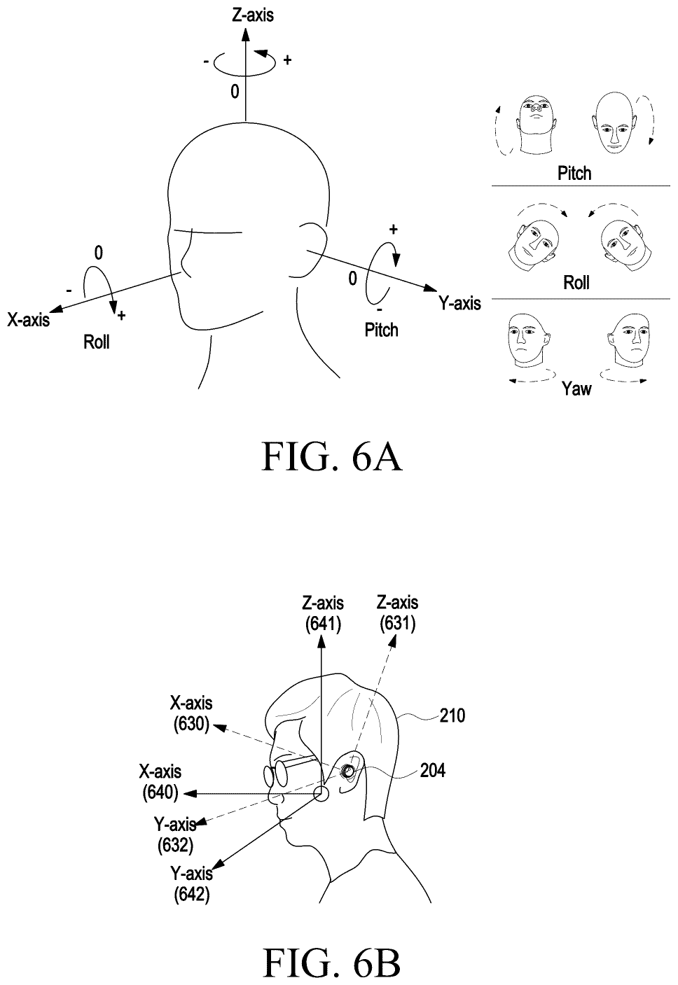

According to an embodiment, the roll data, the pitch data, and the yaw data may refer to angular data for rotational motion about reference coordinate axes (e.g., the x-axis, the y-axis, and the z-axis), respectively, in a three-dimensional space. The x-axis, the y-axis, and the z-axis may refer to axes that are orthogonal to each other. For example, the z-axis may be defined as an up-down axis relative to a reference point (e.g., an axis parallel to the direction of gravity). The x-axis may be defined as a front-back axis relative to the reference point. The y-axis may be defined as a left-right axis relative to the reference point. The roll data may refer to angular data for rotational motion about the x-axis, the pitch data may refer to angular data for rotational motion about the y-axis, and the yaw data may refer to angular data for rotational motion about the z-axis. According to an embodiment, the roll data, the pitch data, or the yaw data will be described in detail in FIG. 6A.

According to an embodiment, based on a sensing value sensed when the user's head is in a specified posture and multiple sensing values sensed when the user's head is in multiple postures (e.g., a posture in which the user's head is maximally tilted downward and a posture in which the user's head is maximally tilted upward) different from the specified posture, the processor 220 may perform calibration for sensing a change in the angle at which the user's head is tilted, relative to the sensing value.

According to an embodiment, the processor 220 may identify a first sensing value, which indicates the number of a user's steps and an angular change of the electronic device 201, via the sensor 276 after performing the calibration. According to an embodiment, the first sensing value may indicate an angle at which the electronic device 201 is tilted relative to the horizontal. According to an embodiment, the first sensing value may include pitch data.

According to an embodiment, the wearable electronic device 204 may identify, via the sensor 277, a second sensing value indicating an angular change of the user's head. According to an embodiment, the processor 220 may receive, via the communication module 290, the second sensing value which indicates the angular change of the user's head and has been identified by the wearable electronic device 204. According to an embodiment, the second sensing value may include pitch data.

According to an embodiment, the processor 220 may identify whether the number of the user's steps, the first sensing value, and the second sensing value satisfy specified conditions. For example, the specified conditions may refer to conditions for identifying or determining whether the user is in a smombie state. For example, when the specified conditions are satisfied, the electronic device 201 may identify or determine that the user is in a smombie state. According to an embodiment, when the number of steps is identified to be greater than a first threshold value, when the absolute value of the first sensing value is identified to be greater than a second threshold value, and when the absolute value of the second sensing value is identified to be greater than a third threshold value obtained through the calibration, the processor 220 may identify that the number of the user's steps, the first sensing value, and the second sensing value satisfy the specified conditions. According to an embodiment, the second threshold value and the third threshold value may be the same value, or may be different values. According to an embodiment, the processor 220 may obtain the third threshold value by converting, through calibration, body frame coordinate axes corresponding to coordinate axes of the user's head to a navigation frame coordinate axis corresponding to reference coordinate axes. For example, the third threshold value may be a threshold value adjusted based on a criterion for a change in the tilt angle of the user's head, established by calibration.

For example, the body frame coordinate axes corresponding to the coordinate axes of the user's head may refer to coordinate axes configured by using the wearable electronic device 204 as a criterion. For example, the criterion of the wearable electronic device 204 may refer to the center of gravity of the wearable electronic device 204, or a location of the sensor 277 of the wearable electronic device 204. However, this is an example, and embodiments of the disclosure may establish the criterion in various ways. The body frame coordinate axes may include an x-axis (e.g., 640 in FIG. 6B), a y-axis (e.g., 642 in FIG. 6B), and a z-axis (e.g., 641 in FIG. 6B) that are orthogonal to each other. The x-axis (e.g., 640 in FIG. 6B) may be defined as a front-back axis relative to the wearable electronic device 204, the z-axis (e.g., 641 in FIG. 6B) may be defined as an up-down axis relative to the wearable electronic device 204, and the y-axis (e.g., 642 in FIG. 6B) may be defined as a left-right axis relative to the wearable electronic device 204.

According to an embodiment, when it is identified that the number of the user's steps, the first sensing value, and the second sensing value satisfy the specified conditions, the processor 220 may use the display 260 and/or the output device 270 to output notification information indicating that the user is in a smombie state. For example, the smombie state may refer to a state in which the user is walking with the head tilted downward to look at the electronic device 201 (e.g., a smartphone). According to an embodiment, the output device 260 may be implemented as a speaker (e.g., the acoustic output module 155 in FIG. 1). According to an embodiment, the processor 220 may provide the notification information tactilely, auditorily, or visually. According to an embodiment, the processor 220 may transmit the notification information to the wearable electronic device 204 via the communication module 290. According to an embodiment, the wearable electronic device 204 may output the notification information as a voice via the output device 271.

According to an embodiment, when it is identified that the number of the user's steps, the first sensing value, and the second sensing value do not satisfy the specified conditions, the processor 220 may identify that the user is not in a smombie state. According to an embodiment, the processor 220 may not output notification information via the display 260 and/or the output device 270, based on identifying that the user is not in a smombie state.

Furthermore, according to an embodiment, when it is identified that the number of the user's steps, the first sensing value, and the second sensing value satisfy the specified conditions, the processor 220 may identify whether the screen of the display 260 is turned on. According to an embodiment, when the screen of the display 260 is identified to be turned on, the processor 220 may output notification information indicating that the user is in a smombie state. According to an embodiment, when it is identified that the screen of the display 260 is not turned on, the processor 220 may identify that the user is not in a smombie state.

According to an embodiment, the electronic device 201 may identify that the user is in a smombie state, based on the tilt angle of the electronic device 201 and the tilt angle of the user's head, and notify the user of danger information. This may prevent the user from being at risk of an accident.

The operations of the electronic device 201, described with reference to the following drawings, may be performed by the processor 220. However, for ease of description, the operations performed by the processor 220 will be described as being performed by the electronic device 201.

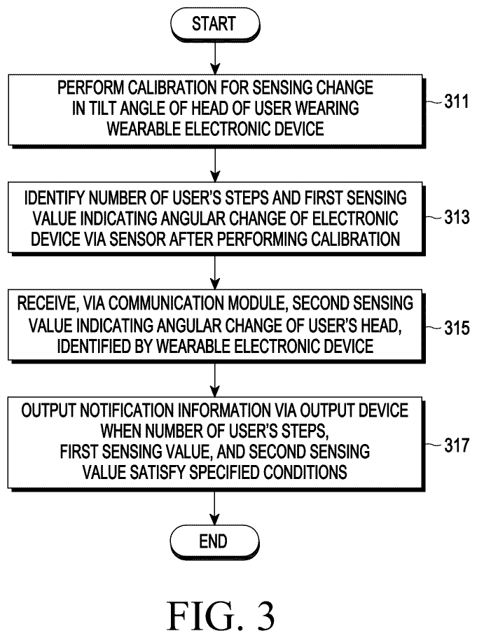

FIG. 3 is a flowchart illustrating a method for operating a wearable electronic device according to an embodiment.

Referring to FIG. 3, according to an embodiment, an electronic device (e.g., the electronic device 201 in FIG. 2B) may identify whether a user is in a smombie state. The electronic device 201 may perform calibration for identifying whether the user is in a smombie state.

According to an embodiment, in operation 311, the electronic device 201 may perform calibration for sensing a change in the tilt angle of the head of a user wearing a wearable electronic device 204 (e.g., the wearable electronic device 204 in FIG. 2B). According to an embodiment, the electronic device 201 may perform calibration to establish a criterion for the change in the tilt angle of the user's head. According to an embodiment, performing the calibration may refer to performing an operation of converting body frame coordinate axes corresponding to coordinate axes of the user's head to navigation frame coordinate axes corresponding to reference coordinate axes, based on sensing values sensed when the user wearing the wearable electronic device 204 is in a specified posture and in multiple postures different from the specified posture.

For example, the navigation frame coordinate axes corresponding to the reference coordinate axes may include an x-axis, a y-axis, and a z-axis that are orthogonal to each other. The z-axis may be defined as an up-down axis (e.g., parallel to the direction of gravitational acceleration) relative to a reference point. The x-axis may be defined as a front-back axis relative to the reference point. The y-axis may be defined as a left-right axis relative to the reference point.

For example, the body frame coordinate axes corresponding to the coordinate axes of the user's head may refer to coordinate axes configured by using the wearable electronic device 204 as a criterion. For example, the criterion of the wearable electronic device 204 may be the center of gravity of the wearable electronic device 204, or a location of the sensor 277 of the wearable electronic device 204. However, this is merely one example, and embodiments of the disclosure may establish the criterion in various ways. The body frame coordinate axes may include an x-axis, a y-axis, and a z-axis that are orthogonal to each other. The x-axis may be defined as a front-back axis relative to the wearable electronic device 204, the z-axis may be defined as an up-down axis relative to the wearable electronic device 204, and the y-axis may be defined as a left-right axis relative to the wearable electronic device 204.

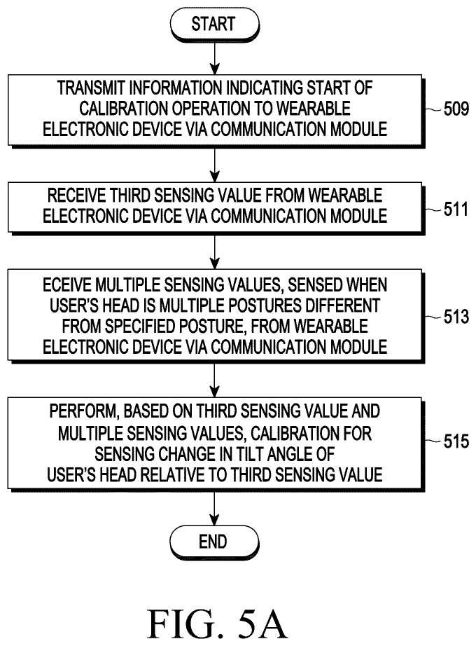

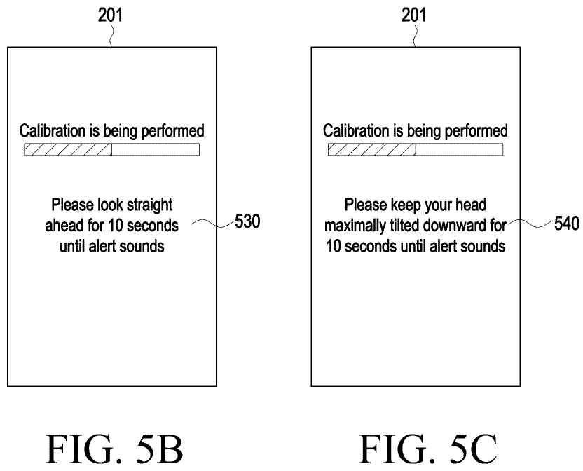

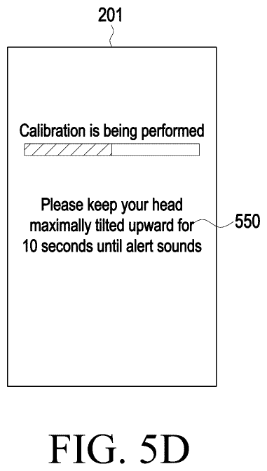

According to an embodiment, the electronic device 201 may receive a sensing value, which is sensed when a user wearing the wearable electronic device 204 is in a specified posture (e.g., a posture in which the user is looking straight ahead without movement of the user's head), from the wearable electronic device 204 via a communication module 290 (e.g., the communication module 290 in FIG. 2B). According to an embodiment, the electronic device 201 may use the communication module 290 to receive, from the wearable electronic device 204, multiple sensing values sensed when the user wearing the wearable electronic device 204 is in multiple postures (e.g., a posture in which the user's head is maximally tilted downward and a posture in which the user's head is maximally tilted upward) different from the specified posture. According to an embodiment, the electronic device 201 may perform, based on the sensing value and the multiple sensing values, calibration for sensing a change in the tilt angle of the user's head relative to the sensing value. According to an embodiment, the electronic device 201 may store calibration data in memory 230 (e.g., the memory 230 in FIG. 2B). For example, the calibration data may refer to at least one sensing value used by the electronic device 201 to perform the calibration. According to an embodiment, when it is identified that the wearable electronic device 204 is connected for communication via the communication module 290, the electronic device 201 may identify whether calibration data for the wearable electronic device 204 is stored in the memory 230. According to an embodiment, the electronic device 201 may not perform a calibration operation when it is identified that the calibration data is stored in the memory 230. According to an embodiment, the electronic device 201 may perform the calibration operation when it is identified that the calibration data is not stored in the memory 230. According to an embodiment, the electronic device 201 may perform the calibration operation when the wearable electronic device 204 is worn by a second user who is different from a first user who performed the calibration. For example, the electronic device 201 may identify that the user wearing the wearable electronic device 204 is different when the posture of the second user wearing the wearable electronic device 204 is different from the posture of the first user who performed the previous calibration. For example, the electronic device 201 may identify that the user wearing the wearable electronic device 204 is different when biometric information of the second user wearing the wearable electronic device 204, identified via the sensor 227 of the wearable electronic device 204, is different from biometric information of the first user who performed the previous calibration. According to an embodiment, the electronic device 201 may configure a calibration performing method for at least one external electronic device, which is different from the wearable electronic device 204, to be different to a calibration performing method for the wearable electronic device 204. According to an embodiment, the electronic device 201 may configure the calibration performing method differently depending on the type of the at least one external electronic device. The process by which the electronic device 201 performs calibration will be described in detail with reference to FIGS. 5A to 5D, 6A, and 6B.

According to an embodiment, in operation 313, after performing the calibration, the electronic device 201 may use a sensor 276 (e.g., the sensor 276 in FIG. 2B) to identify the number of a user's steps and a first sensing value indicating an angular change of the electronic device 201. According to an embodiment, the first sensing value may refer to an angle at which the electronic device 201 is tilted, relative to the horizontal.

According to an embodiment, in operation 315, the electronic device 201 may receive, via the communication module 290, a second sensing value indicating an angular change of the user's head, identified by the wearable electronic device 204. According to an embodiment, the second sensing value may be an angle at which the wearable electronic device 204 is tilted relative to a sensing value, based on the sensing value obtained when the user is in the specified posture (e.g., a posture in which the user is looking straight ahead without any movement of the user's head) obtained through the calibration and multiple sensing values obtained when the user is in multiple postures (e.g., a posture in which the user's head is maximally tilted downward and a posture in which the user's head is maximally tilted upward) different from the specified posture.

According to an embodiment, in operation 317, the electronic device 201 may output notification information via a display 260 (e.g., the display 260 in FIG. 2B) and/or an output device 270 (e.g., the output device 270 in FIG. 2B) when the number of the user's steps, the first sensing value, and the second sensing value satisfy specified conditions. For example, the specified conditions may refer to conditions for identifying or determining whether the user is in a smombie state. For example, when the specified conditions are satisfied, the electronic device 201 may identify or determine that the user is in a smombie state.

According to an embodiment, when the number of steps is identified to be greater than a first threshold value, when the absolute value of the first sensing value is identified to be greater than a second threshold value (e.g., 30 degrees), and when the absolute value of the second sensing value is identified to be greater than a third threshold value (e.g., 30 degrees), the electronic device 201 may identify that the number of the user's steps, the first sensing value, and the second sensing value satisfy the specified conditions. According to an embodiment, the third threshold value may be obtained through calibration. For example, the third threshold value may be a threshold value adjusted based on a criterion for a change in the tilt angle of the user's head, established by calibration.

According to an embodiment, the notification information may include information indicating that the user is in a smombie state. For example, the smombie state may refer to a state in which the user is walking with the head tilted downward to look at the electronic device 201 (e.g., a smartphone).

According to an embodiment, the output device 270 may be implemented as a speaker. According to an embodiment, the electronic device 201 may provide the notification information via auditory (e.g., voice or sound), tactile (e.g., vibration), and/or visual means (e.g., displaying a pop-up window).

According to an embodiment, the electronic device 201 may transmit the notification information to the wearable electronic device 204 via the communication module 290. According to an embodiment, the wearable electronic device 204 may output the notification information received from the electronic device 201 as a voice, sound, and/or vibration.

According to an embodiment, when it is identified that the number of the user's steps, the first sensing value, and the second sensing value do not satisfy the specified conditions, the electronic device 201 may determine that the user is not in a smombie state. According to an embodiment, the electronic device 201 may not output notification information, based on determining that the user is not in a smombie state.

According to an embodiment, the electronic device 201 may, periodically or at a specified time, perform an operation of determining whether the number of the user's steps, the first sensing value, and the second sensing value satisfy specified conditions.

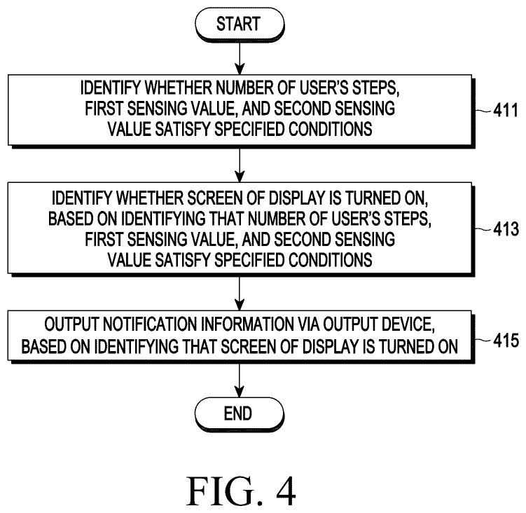

FIG. 4 is a flowchart illustrating a method for operating a wearable electronic device according to an embodiment.

Referring to FIG. 4, according to an embodiment, in operation 411, an electronic device 201 (e.g., the electronic device 201 in FIG. 2B) may identify whether the number of a user's steps, a first sensing value indicating an angular change of the electronic device 201, and a second sensing value indicating an angular change of the user's head satisfy specified conditions. For example, the specified conditions may refer to conditions for identifying or determining whether the user is in a smombie state. For example, when the specified conditions are satisfied, the electronic device 201 may identify or determine that the user is in a smombie state.

According to an embodiment, the electronic device 201 may identify the number of steps and the first sensing value via a sensor 276 (e.g., the sensor 276 in FIG. 2B). According to an embodiment, the electronic device 201 may identify the second sensing value identified by a wearable electronic device 204 (e.g., the wearable electronic device 204 in FIG. 2B) via a communication module 290 (e.g., the communication module 290 in FIG. 2B).

According to an embodiment, the electronic device 201 may identify that the number of the user's steps, the first sensing value, and the second sensing value satisfy the specified conditions when it is identified that the number of steps is greater than a first threshold value, the absolute value of the first sensing value is greater than a second threshold value (e.g., 30 degrees), and the absolute value of the second sensing value is greater than a third threshold value (e.g., 30 degrees). According to an embodiment, the third threshold value may be obtained through calibration. For example, the third threshold value may be a threshold value adjusted based on a criterion for a change in the tilt angle of the user's head, established by calibration.

According to an embodiment, in operation 413, the electronic device 201 may identify whether a screen of a display 260 (e.g., the display 260 in FIG. 1) is turned on, based on identifying that the number of the user's steps, the first sensing value, and the second sensing value satisfy the specified conditions.

According to an embodiment, in operation 415, the electronic device 201 may output notification information via the display 260 and/or an output device 270 (e.g., the output device 270 in FIG. 2B), based on identifying that the screen of the display 260 is turned on. According to an embodiment, the notification information may include information indicating that the user is in a smombie state. For example, the smombie state may refer to a state in which the user is walking with the head tilted downward to look at the electronic device 201 (e.g., a smartphone).

According to an embodiment, the electronic device 201 may control the wearable electronic device 204 to output the notification information via the wearable electronic device 204. For example, the wearable electronic device 204 may output the notification information as a voice and/or vibration via an output device 271 (e.g., the output device 271 in FIG. 2C).

According to an embodiment, when it is identified that the screen of the display 260 is not turned on, the electronic device 201 may determine that the user is not in a smombie state. For example, even when the number of the user's steps, the first sensing value, and the second sensing value satisfy specified conditions, the electronic device 201 may determine that the user is not in a smombie state, when the screen of the display 260 is identified to be turned off. According to an embodiment, the electronic device 201 may not output notification information, based on the determination that the user is not in a smombie state.

By using the above-described method, the electronic device 201 may output notification information to a user who is identified as walking the street while looking at the electronic device 201 (e.g., a smartphone) without looking straight ahead, thereby preventing an accident.

FIG. 5A is a flowchart illustrating an operation method for performing calibration by an electronic device according to an embodiment.

Referring to FIG. 5A, in a posture where a user is looking straight ahead without any movement of the user's head, the sensing value (e.g., angle value) sensed by a wearable electronic device 204 (e.g., the wearable electronic device 204 in FIG. 2B) may vary each time. According to an embodiment, an electronic device 201 (e.g., the electronic device 201 in FIG. 2B) may perform calibration in order to set a reference value. According to an embodiment, the electronic device 201 may perform an operation of setting a sensing value, obtained when the user is in a specified posture (e.g., a posture in which the user is looking straight ahead without any movement of the user's head), as the reference value.

According to an embodiment, the electronic device 201 may perform calibration based on an input from a user wearing the wearable electronic device 204. According to an embodiment, when it is identified that the wearable electronic device 204 has been worn by the user, the electronic device 201 may identify whether calibration data is stored in memory 230 (e.g., the memory 230 in FIG. 2B). According to an embodiment, the electronic device 201 may not perform a calibration operation when calibration data for the wearable electronic device 204 is identified. According to an embodiment, the electronic device 201 may perform a calibration operation when the calibration data for the wearable electronic device 204 is not identified. For example, the calibration data may refer to at least one sensing value used by the electronic device 201 to perform the calibration.

According to an embodiment, in operation 509, the electronic device 201 may transmit information indicating the start of the calibration operation to the wearable electronic device 204 via a communication module 290 (e.g., the communication module 290 in FIG. 2B). According to an embodiment, the wearable electronic device 204 may output the information indicating the start of the calibration operation via an output device 271 (e.g., the output device 271 in FIG. 2C). According to an embodiment, the electronic device 201 may also output the information indicating the start of the calibration operation via a display 260 and/or an output device 270. According to an embodiment, the information indicating the start of the calibration operation may include notification information that causes the user wearing the wearable electronic device 204 to maintain a specified posture (e.g., a posture in which the user is looking straight ahead without head movement) for a predetermined time.

According to an embodiment, the electronic device 201 may transmit the information indicating the start of the calibration operation to the wearable electronic device 204 via the communication module 290. According to an embodiment, when the information is received, the wearable electronic device 204 may output the notification information, which causes the user to maintain the specified posture for the predetermined time, as a voice via the output device 271. For example, the wearable electronic device 204 may output “Please look straight ahead for 10 seconds” as a voice. In some embodiments, the electronic device 201 may auditorily or visually output “Please look straight ahead for 10 seconds” via an output device 270 (e.g., the output device 270 in FIG. 2B) and/or display 260.

According to an embodiment, in operation 511, the electronic device 201 may receive a third sensing value from the wearable electronic device 204 via the communication module 290. According to an embodiment, the wearable electronic device 204 may obtain the multiple sensing values via a sensor 277 (e.g., the sensor 277 in FIG. 2C). According to an embodiment, the wearable electronic device 204 may identify, based on the multiple sensing values obtained for a predetermined time, whether the user maintains the specified posture for the predetermined time (e.g., 10 seconds). For example, the wearable electronic device 204 may identify that the user maintains the specified posture for the predetermined time, when the multiple sensing values obtained for the predetermined time via the sensor 277 are equal to each other, or when the difference between the multiple sensing values is within a predetermined range. According to an embodiment, when it is identified that the user maintains the specified posture for the predetermined time, the wearable electronic device 204 may transmit the third sensing value included in the multiple sensing values to the electronic device 201 via a communication module 291. In some embodiments, an average value of the multiple obtained sensing values may be transmitted to the electronic device 201. According to an embodiment, when it is identified that the user does not maintain the specified posture for the predetermined time, the wearable electronic device 204 may not transmit the sensing value to the electronic device 201 and may re-output notification information that causes the user to maintain the specified posture for the predetermined time.

For example, the third sensing value may include at least one of roll data or pitch data.

According to an embodiment, roll data, pitch data, and yaw data may refer to angular data for rotational motion about a center axis about the x-axis, the y-axis, and the z-axis, respectively, in a three-dimensional space. The x-axis, the y-axis, and the z-axis may refer to reference coordinate axes that are orthogonal to each other. For example, the z-axis may be defined as an up-down axis relative to a reference point (e.g., an axis parallel to the direction of gravity). The x-axis can be defined as a front-back axis relative to the reference point. The y-axis can be defined as a left-right axis relative to the reference point. Roll data may refer to angular data for rotational motion about the x-axis, pitch data may refer to angular data for rotational motion about the y-axis, and yaw data may refer to angular data for rotational motion about the z-axis.

According to an embodiment, the wearable electronic device 204 may transmit the third sensing value to the electronic device 201 via a communication module 291 (e.g., the communication module 291 in FIG. 2C) when it is identified that the user maintains the specified posture for the predetermined time.

According to an embodiment, in operation 513, the electronic device 201 may receive multiple sensing values, which have been sensed when the user's head is in multiple postures different from the specified posture, from the wearable electronic device 204 via the communication module 290. According to an embodiment, the multiple postures may include a posture in which the user's head is maximally tilted downward and a posture in which the user's head is maximally tilted upward.

According to an embodiment, the electronic device 201 may transmit a request signal, which requests a sensing value obtained when the user's head is in the maximally downward-tilted posture, to the wearable electronic device 204 via the communication module 290. According to an embodiment, when the request signal is received, the wearable electronic device 204 may output a voice to ensure that the user's head remains in the maximally downward-tilted posture for a predetermined time. For example, the wearable electronic device 204 may output a voice saying “Please keep your head maximally tilted downward for 10 seconds.” In some embodiments, the electronic device 201 may output “Please keep your head maximally tilted downward for 10 seconds” via the output device 270 and/or the display 260. According to an embodiment, the wearable electronic device 204 may obtain the sensing value via the sensor 277 when the user's head is in the maximally downward-tilted posture. According to an embodiment, the electronic device 201 may transmit a request signal, which requests a sensing value obtained when the user's head is in a maximally upward-tilted posture, to the wearable electronic device 204 via the communication module 290. According to an embodiment, when the request signal is received, the wearable electronic device 204 may output a voice to ensure that the user's head remains in the maximally upward-tilted posture for a predetermined time. For example, the wearable electronic device 204 may output a voice saying “Please keep your head maximally tilted upward for 10 seconds.” In some embodiments, the electronic device 201 may output “Please keep your head maximally tilted upward for 10 seconds” by using a visual or auditory means via the output device 270 and/or the display 260. According to an embodiment, the wearable electronic device 204 may obtain the sensing value via the sensor 277 when the user's head is in the maximally upward-tilted posture. According to an embodiment, the wearable electronic device 204 may transmit, to the electronic device 201, multiple sensing values obtained when the user's head is in a maximally downward-tilted posture and when the user's head is in a maximally upward-tilted posture. According to an embodiment, the multiple sensing values may include at least one of roll data, pitch data, or yaw data.

According to an embodiment, in operation 515, based on the third sensing value sensed based on the information indicating the start of performing the calibration and the multiple sensing values sensed when the user's head is in the multiple postures (e.g., a posture in which the user's head is maximally tilted downward and a posture in which the user's head is maximally tilted upward) different from the specified posture, the electronic device 201 may perform calibration for sensing a change in the tilt angle of the user's head relative to the third sensing value. According to an embodiment, the electronic device 201 may perform calibration to establish a criterion for a change in the tilt angle of the user's head. According to an embodiment, performing the calibration may refer to performing an operation of converting body frame coordinate axes corresponding to coordinate axes of the user's head to navigation frame coordinate axes corresponding to reference coordinate axes.

For example, the body frame coordinate axes corresponding to the coordinate axes of the user's head may refer to coordinate axes configured relative to the wearable electronic device 204. The body frame coordinate axes may include an x-axis, a y-axis, and a z-axis that are orthogonal to each other. The x-axis may be defined as a front-back axis relative to the wearable electronic device 204, the z-axis may be defined as an up-down axis relative to the wearable electronic device 204, and the y-axis may be defined as a left-right axis relative to the wearable electronic device 204.

FIG. 5B illustrates a screen displayed on a display when an electronic device according to an embodiment performs calibration.

Referring to FIG. 5B, according to an embodiment, an electronic device 201 may transmit information indicating the start of a calibration operation to a wearable electronic device 204 (e.g., the wearable electronic device 204 in FIG. 2B) via a communication module 290 (e.g., the communication module 290 in FIG. 2B). According to an embodiment, the information indicating the start of the calibration operation may include notification information that causes a user wearing the wearable electronic device 204 to maintain a specified posture (e.g., a posture in which the user is looking straight ahead without head movement) for a predetermined time.

According to an embodiment, when transmitting, to the wearable electronic device 204, the information indicating the start of the calibration operation, the electronic device 201 may use a display 260 (e.g., display 260 in FIG. 2B) to visually output the notification information that causes the user to maintain the specified posture for the predetermined time. According to an embodiment, the electronic device 201 may display a screen 530 on the display when transmitting the information to the wearable electronic device 204.

According to an embodiment, the screen 530 may include information indicating that calibration is being performed (e.g., calibration is being performed), information indicating the extent to which the calibration is being performed (e.g., a bar icon), and notification information that causes the user to maintain a specified posture for a predetermined time (e.g., 10 seconds) (e.g., Please look straight ahead for 10 seconds until the alert sounds).

In addition, according to an embodiment, the electronic device 201 may control the wearable electronic device 204 to output, via the wearable electronic device 204, the notification information that causes the user to maintain the specified posture for the predetermined time (e.g., 10 seconds). For example, the wearable electronic device 204 may output, via an output device, a voice saying “Please look straight ahead for 10 seconds until the alert sounds.”

According to an embodiment, when the information indicating the start of the calibration operation is received, the wearable electronic device 204 may obtain at least one sensing value via a sensor 277 (e.g., the sensor 277 in FIG. 2C) for a predetermine time (e.g., 10 seconds). According to an embodiment, when the multiple sensing values obtained for the predetermined time (e.g., 10 seconds) via the sensor 277 are equal to each other, or when the difference between the multiple sensing values is within a predetermined range, the wearable electronic device 204 may identify that the user maintains the specified posture for the predetermined time.

According to an embodiment, when it is identified that the user maintains the specified posture for the predetermined time, the wearable electronic device 204 may transmit a third sensing value included in the multiple sensing values to the electronic device 201 via a communication module 291. According to an embodiment, the electronic device 201 may receive the third sensing value from the wearable electronic device 204.

According to an embodiment, when the information indicating the start of the calibration operation is received, the wearable electronic device 204 may obtain multiple sensing values via the sensor 277, based on a specified period or a specified number of times. When it is identified, based on the multiple sensing values, that the user maintains the specified posture for the predetermined time, the wearable electronic device 204 may transmit at least one sensing value included in the multiple sensing values to the electronic device 201, or may transmit an average value of the multiple sensing values obtained based on the specified period or the specified number of times to the electronic device 201.

FIG. 5C illustrates a screen displayed on a display when an electronic device according to an embodiment performs calibration.

Referring to FIG. 5C, according to an embodiment, an electronic device 201 may transmit a request signal, which requests a wearable electronic device 204 to obtain a sensing value when a user's head is in a maximally downward-tilted posture, to the wearable electronic device 204 via a communication module 290 (e.g., the communication module 290 in FIG. 2B).

According to an embodiment, when transmitting the request signal to the wearable electronic device 204, the electronic device 201 may visually output, via a display 260 (e.g., display 260 in FIG. 2B), notification information that causes the user's head to remain in the maximally downward-tilted posturer for a predetermined time (e.g., 10 seconds).

According to an embodiment, the electronic device 201 may display a screen 540 on a display 260 when transmitting the request signal to the wearable electronic device 204.

According to an embodiment, the screen 540 may include information that calibration is being performed (e.g., calibration is being performed), information indicating the extent to which the calibration is being performed (e.g., a bar icon), and the notification information that causes the user's head to remain in the maximally downward-tilted posture for the predetermined time (e.g., 10 seconds) (e.g., please keep your head maximally tilted downward for 10 seconds until the alert sounds.).

In addition, according to an embodiment, the electronic device 201 may control the wearable electronic device 204 to output, via the wearable electronic device 204, the notification information that the user's head remains in the maximally downward-tilted down posture for the predetermined time. For example, the wearable electronic device 204 may output a voice saying “Please keep your head maximally downward for 10 seconds until the alert sounds.”

According to an embodiment, when the request signal, which requests the wearable electronic device 204 to obtain the sensing value when the user's head is in the maximally downward-tilted posture, is received, the wearable electronic device 204 may obtain sensing values via a sensor 277 (e.g., the sensor 277 in FIG. 2C), based on a specified period or a specified number of times. For example, the wearable electronic device 204 may transmit, to the electronic device 201, the sensing values obtained based on the specified period or the specified number of times, or may transmit, to the electronic device 201, an average value of the sensing values obtained based on the specified period or the specified number of times.

FIG. 5D illustrates a screen displayed on a display when an electronic device according to an embodiment performs calibration.

Referring to FIG. 5D, according to an embodiment, an electronic device 201 may transmit a request signal, which requests a wearable electronic device 204 to obtain a sensing value when a user's head is in a maximally upward-tilted posture, to the wearable electronic device 204 via a communication module 290 (e.g., the communication module 290 in FIG. 2B).

According to an embodiment, when transmitting the request signal to the wearable electronic device 204, the electronic device 201 may visually output, via a display 260 (e.g., display 260 in FIG. 2B), notification information that causes the user's head to remain in the maximally upward-tilted posture for a predetermined time (e.g., 10 seconds).

According to an embodiment, the electronic device 201 may display a screen 550 on the display 260 when transmitting the request signal to the wearable electronic device 204.

According to an embodiment, the screen 550 may include information that calibration is being performed (e.g., calibration is being performed), information indicating the extent to which the calibration is being performed (e.g., a bar icon), and the notification information that causes the user's head to remain in the maximally upward-tilted posture for the predetermined time (e.g., 10 seconds) (e.g., please keep your head maximally tilted upward for 10 seconds until the alert sounds).

In addition, according to an embodiment, the electronic device 201 may control the wearable electronic device 204 to output the notification information via the wearable electronic device 204. For example, the wearable electronic device 204 may output a voice saying “Please keep your head maximally tilted upward for 10 seconds until the alert sounds.”

According to an embodiment, when the request signal, which requests the wearable electronic device 204 to obtain the sensing value when the user's head is in the maximally upward-tilted posture, is received, the wearable electronic device 204 may obtain sensing values via a sensor 277 (e.g., the sensor 277 in FIG. 2C), based on a specified period or a specified number of times. For example, the wearable electronic device 204 may transmit, to the electronic device 201, the sensing values obtained based on the specified period or the specified number of times, or may transmit, to the electronic device 201, an average value of the sensing values obtained based on the specified period or the specified number of times.

FIG. 6A illustrates roll, pitch, and yaw data according to an embodiment.

The x-axis, the y-axis, and the z-axis may refer to reference coordinate axes that are orthogonal to each other. For example, the z-axis may be defined as an up-down axis relative to a reference point (e.g., an axis parallel to the direction of gravity). The x-axis may be defined as a front-back axis relative to the reference point. The y-axis may be defined as a left-right axis relative to the reference point.

Roll data, pitch data, and yaw data may refer to angular data for rotational motion about the x-axis, the y-axis, and the z-axis, respectively, in a three-dimensional space. The roll data may refer to an angular data for rotational motion about the x-axis, the pitch data may refer to angular data for rotational motion about the y-axis, and the yaw data may refer to angular data for rotational motion about the z-axis.

For example, the pitch data may refer to angular data for rotational motion in which a user wearing a wearable electronic device 204 (e.g., the wearable electronic device 204 in FIG. 2B) moves the head up and down. The roll data may refer to angular data for rotational motion in which the user wearing the wearable electronic device 204 moving the head from one shoulder to the other shoulder. The yaw data may refer to angular data for rotational motion in which the user wearing the wearable electronic device 204 moves the head left and right.

FIG. 6B illustrates an operation of performing calibration by an electronic device according to an embodiment.

According to an embodiment, an electronic device 201 (e.g., the electronic device 201 in FIG. 2B) may perform calibration to establish a criterion for a change in the tilt angle of a user's head 210.

According to an embodiment, performing calibration may refer to performing an operation of converting body frame coordinate axes corresponding to coordinate axes of the head 210 of the user wearing a wearable electronic device 204 (e.g., the wearable electronic device 204 in FIG. 2B) to navigation frame coordinate axes corresponding to reference coordinate axes.

For example, the navigation frame coordinate axes corresponding to the reference coordinate axes may include an x-axis 640, a y-axis 642, and a z-axis 641 that are orthogonal to each other. The z-axis 641 may be defined as an up-down axis (e.g., an axis parallel to the direction of gravitational acceleration). The x-axis 640 may be defined as a front-back axis. The y-axis 642 may be defined as a left-right axis.

For example, the body frame coordinate axes corresponding to the coordinate axes of the user's head 210 may refer to coordinate axes configured by using the wearable electronic device 204 as a criterion. For example, the criterion of the wearable electronic device 204 may refer to the center of gravity of the wearable electronic device 204, or a location of a sensor 277. However, this is an example, and embodiments of the disclosure may establish the criterion in various ways. The body frame coordinate axes may include an x-axis 630, a y-axis 632, and a z-axis 631 that are orthogonal to each other. The x-axis 630 may be defined as a front-back axis relative to the wearable electronic device 204, the z-axis 631 may be defined as an up-down axis relative to the wearable electronic device 204, and the y-axis 632 may be defined as a left-right axis relative to the wearable electronic device 204.

According to an embodiment, the electronic device 201 may adjust a threshold value (e.g., a threshold value for an angular change of the user's head), which has been set relative to the navigation frame coordinate axes corresponding to the reference coordinate axes, relative to the body frame coordinate axes corresponding to the coordinate axes of the user's head 210.

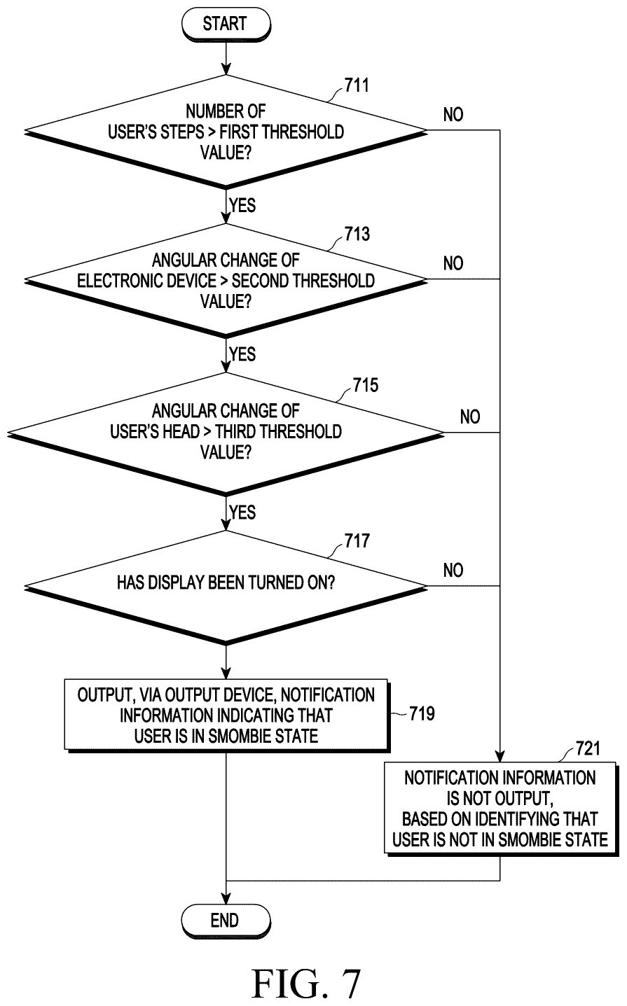

FIG. 7 is a flowchart illustrating a method for operating an electronic device, according to an embodiment.

In the following embodiments, operations may be performed sequentially, but are not necessarily performed sequentially. For example, the order of the operations may be changed, and the operations may be performed in parallel.

According to an embodiment, in operation 711, an electronic device 201 (e.g., the electronic device 201 in FIG. 2B) may identify whether the number of the user's steps is greater than a first threshold. According to an embodiment, the electronic device 201 may identify the number of the user's steps via a sensor 276 (e.g., the sensor 276 in FIG. 2B) for a predetermined time. For example, the first threshold value may be set by a user or may be set by a processor 220 (e.g., the processor 220 in FIG. 2B). When it is identified that the number of the user's steps is greater than the first threshold value, the electronic device 201 may determine that the user is in a moving state (e.g., a walking state).

According to an embodiment, when it is identified that the number of the user's steps is not greater than the first threshold (operation 711—No), the electronic device 201 may identify, in operation 721, that the user is not in a smombie state. According to an embodiment, the electronic device 201 may not output notification information via a display 260 (e.g., the display 260 in FIG. 2B) and/or an output device 270 (e.g., the output device 270 in FIG. 2B), based on identifying that the user is not in a smombie state. For example, the smombie state may refer to a state in which the user walks with the head tilted downward to look at the electronic device 201 (e.g., a smartphone).

According to an embodiment, when it is identified that the number of the user's steps is greater than the first threshold value (operation 711—Yes), the electronic device 201 may identify, in operation 713, whether the absolute value of the first sensing value indicating an angular change of the electronic device 201 is greater than a second threshold value (e.g., 30 degrees). According to an embodiment, the electronic device 201 may identify the first sensing value via the sensor 276. According to an embodiment, the first sensing value may indicate an angle at which the electronic device 201 is tilted relative to the horizontal. According to an embodiment, the second threshold value (e.g., 30 degrees) may be set by a user or may be set by the processor 220.

According to an embodiment, when it is identified that the absolute value of the first sensing value indicating the angular change of the electronic device 201 is greater than the second threshold value (e.g., operation 713—Yes), the electronic device 201 may identify, in operation 715, whether the absolute value of the second sensing value indicating an angular change of the user's head is greater than a third threshold value (e.g., 30 degrees) obtained through calibration. According to an embodiment, the electronic device 201 may receive the second sensing value via a communication module 290 (e.g., the communication module 290 in FIG. 2B). According to an embodiment, the second sensing value may be an angle at which a wearable electronic device 204 is tilted relative to the third sensing value obtained by the electronic device 201 through calibration when the user is in a specified posture (e.g., a posture in which the user is looking straight ahead without any movement of the user's head). According to an embodiment, the electronic device 201 may obtain the third threshold value by converting body frame coordinate axes corresponding to coordinate axes of the user's head to navigation frame coordinate axes corresponding to reference coordinate axes. According to an embodiment, the third threshold value may be obtained through calibration. For example, the third threshold value may refer to a threshold value adjusted based on a criterion for a change in the tilt angle of the user's head, established by calibration.

According to an embodiment, when it is identified that the absolute value of the first sensing value indicating the angular change of the electronic device 201 is not greater than the second threshold value (operation 713—No), the electronic device 201 may identify, in operation 721, that the user is not in a smombie state. According to an embodiment, the electronic device 201 may not output notification information via the display 260 and/or the output device 270, based on identifying that the user is not in a smombie state.

According to an embodiment, when it is identified that the absolute value of the second sensing value indicating the angular change of the user's head is greater than the third threshold value (e.g., 30 degrees) (operation 715—Yes), the electronic device 201 may identify, in operation 717, whether a screen of a display 160 (e.g., the display 160 in FIG. 1) is turned on.

According to an embodiment, when it is identified that the absolute value of the second sensing value indicating the angular change of the user's head is not greater than the third threshold value (e.g., 30 degrees) (operation 715—No), the electronic device 201 may identify, in operation 721, that the user is not in a smombie state. According to an embodiment, the electronic device 201 may not output notification information via the display 260 and/or the output device 270, based on identifying that the user is not in a smombie state.

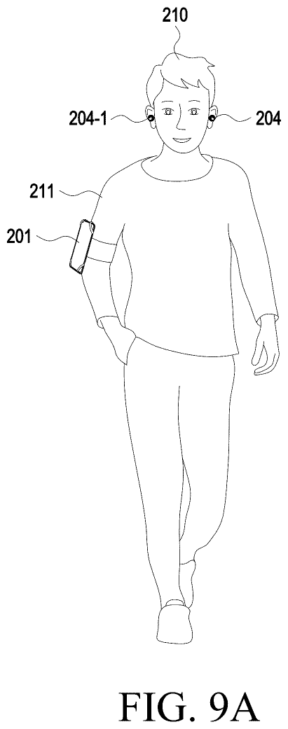

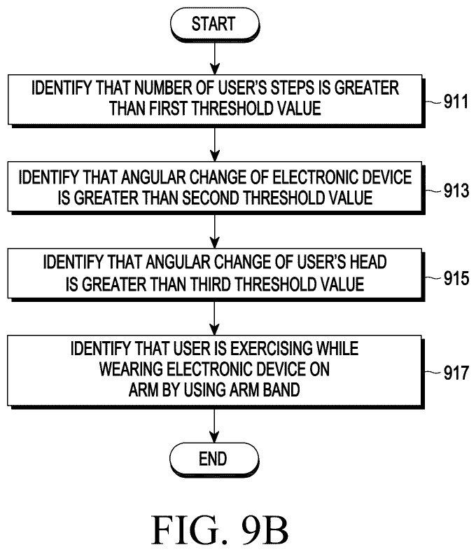

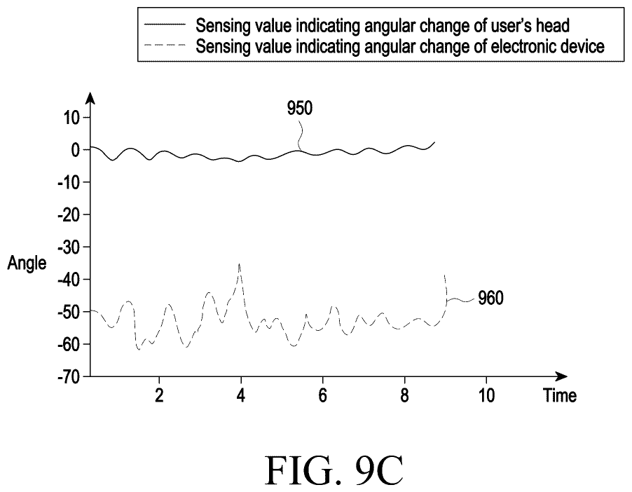

According to an embodiment, when it is identified that the absolute value of the second sensing value indicating the angular change of the user's head is not greater than the third threshold value (e.g., 30 degrees) (operation 715—No), the electronic device 201 may identify that the user is exercising (e.g., walking) while wearing the electronic device 201 on the arm (or, forearm) by using an arm band. In some embodiments, the electronic device 201 may identify that the user is exercising while holding the electronic device 201 in the user's hand. The operation of the electronic device 201 identifying that the user is exercising (e.g., walking) while wearing the electronic device 201 on the arm (or, forearm) by using an arm band will be described in detail with reference to FIGS. 9A to 9C.

According to an embodiment, when it is identified that the screen of the display 260 is turned on (e.g., operation 717—Yes), the electronic device 201 may, in operation 719, output notification information, indicating that the user is in a smombie state, via the display 260 and/or the output device 270 (e.g., the output device 270 in FIG. 2B). According to an embodiment, the electronic device 201 may provide the notification information via auditory (e.g., voice or sound), tactile (e.g., vibration), and/or visual means (e.g., displaying a pop-up window). According to an embodiment, the electronic device 201 may transmit the notification information to the wearable electronic device 204 via the communication module 290. According to an embodiment, the wearable electronic device 204 may output the notification information received from the electronic device 201 as a voice, sound, and/or vibration.

According to an embodiment, when it is identified that the screen of the display 260 is turned off (operation 717—No), the electronic device 201 may identify, in operation 721, that the user is not in a smombie state. According to an embodiment, the electronic device 201 may not output notification information via the display 260 and/or the output device 270, based on identifying that the user is not in a smombie state.

According to an embodiment, the electronic device 201 may perform operations 711, 713, 715, and 717 sequentially, may perform the operations in a different order, or may perform two or more operations in parallel.

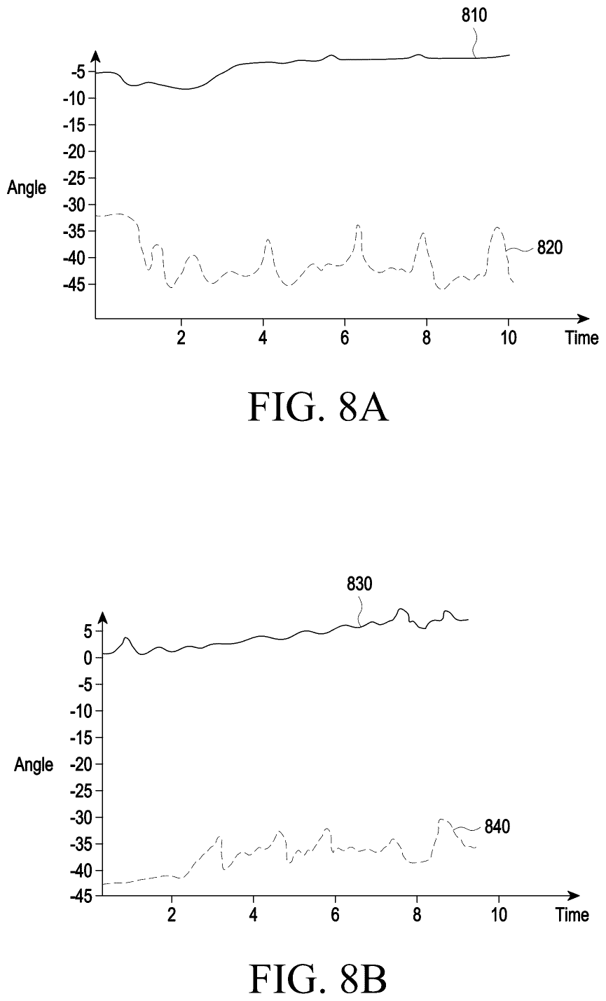

FIG. 8A is a graph showing sensing values indicating angular changes of an electronic device according to an embodiment.

According to an embodiment, the horizontal axis may represent the time at which the sensing values are measured. According to an embodiment, the vertical axis may represent the angle.

According to an embodiment, an electronic device 201 (e.g., the electronic device 201 in FIG. 2B) may identify sensing values 810 and 820, indicating angular changes of the electronic device 201 relative to the horizontal, via a sensor 276 (e.g., the sensor 276 in FIG. 2B). According to an embodiment, the sensing values 810 and 820 may represent pitch data.

According to an embodiment, the electronic device 201 may identify whether the absolute values of the sensing values 810 and 820 is greater than the absolute value (e.g., 30 degrees) of a threshold value. For example, the threshold value may be set to 30 degrees.

According to an embodiment, the electronic device 201 may identify that the absolute value of the sensing value 820 is greater than the threshold value (e.g., 30 degrees). According to an embodiment, based on identifying that the absolute value of the sensing value 820 is greater than the threshold value (e.g., 30 degrees), the electronic device 201 may identify that the sensing value 820 satisfies a specified condition. The specified condition may refer to a condition for identifying or determining whether a user is in a smombie state.

According to an embodiment, the electronic device 201 may identify that the absolute value of the sensing value 810 is less than the threshold value (e.g., 30 degrees). According to an embodiment, based on identifying that the absolute value of the sensing value 810 is less than the threshold value (e.g., 30 degrees), the electronic device 201 may identify that the sensing value 810 does not satisfy the specified condition.

FIG. 8B is a graph showing sensing values indicating angular changes of a user's head according to an embodiment.

According to an embodiment, the horizontal axis may represent the time at which the sensing values are measured. According to an embodiment, the vertical axis may represent the angle.

According to an embodiment, a wearable electronic device 204 (e.g., the wearable electronic device 204 in FIG. 2B) may identify, via a sensor, sensing values 830 and 840 indicating angular changes of the user's head. According to an embodiment, the sensing values 830 and 840 may represent pitch data.

According to an embodiment, the wearable electronic device 204 may transmit the sensing values 830 and 840 to an electronic device 201 (e.g., the electronic device 201 in FIG. 2B).

According to an embodiment, the electronic device 201 may receive the sensing values 830 and 840 via a communication module 290 (e.g., the communication module 290 in FIG. 2B).

According to an embodiment, the electronic device 201 may identify whether the absolute values of the sensing values 830 and 840 are greater than a threshold value (e.g., 30 degrees). According to an embodiment, the threshold value may be a threshold value adjusted based on a criterion for a change in the tilt angle of the user's head, established by calibration.

According to an embodiment, the electronic device 201 may identify that the absolute value of the sensing value 840 is greater than the threshold value (e.g., 30 degrees). According to an embodiment, based on identifying that the absolute value of the sensing value 840 is greater than the threshold value (e.g., 30 degrees), the electronic device 201 may identify that the sensing value 840 satisfies a specified condition.

According to an embodiment, the electronic device 201 may identify that the absolute value of the sensing value 830 is less than the threshold value (e.g., 30 degrees). According to an embodiment, based on identifying that the absolute value of the sensing value 830 is less than the threshold value (e.g., 30 degrees), the electronic device 201 may identify that the sensing value 830 does not satisfy the specified condition.

FIG. 9A illustrates an operation in which an electronic device according to an embodiment identifies that a user is not in a smombie state and is walking while the electronic device is being worn on the user's arm.

According to an embodiment, a wearable electronic device 204 (e.g., the wearable electronic device 204 in FIG. 2B) may be worn by the user.

According to an embodiment, an electronic device 201 (e.g., the electronic device 201 in FIG. 2B) may establish a communication connection with the wearable electronic device 204 via a communication module 290 (e.g., the communication module 290 in FIG. 2B).

According to an embodiment, the electronic device 201 may identify the number of the user's steps for a predetermined time via a sensor 276 (e.g., the sensor 276 in FIG. 2B).

According to an embodiment, the electronic device 201 may identify, via the sensor 276, a first sensing value indicating an angular change of the electronic device. According to an embodiment, the electronic device 201 may identify a second sensing value indicating an angular change of the user's head 210. For example, the electronic device 201 may identify the second sensing value indicating the angular change of the user's head 210, based on sensing values received from the wearable electronic device 204.

According to an embodiment, when it is identified that the number of the user's steps is greater than a first threshold value, the absolute value of the first sensing value is greater than a second threshold value, and the absolute value of the second sensing value is less than a third threshold value, the electronic device 201 may identify that the user is exercising (e.g., walking) while wearing the electronic device 201 on the arm (or, forearm) 211 by using the arm band. According to an embodiment, the electronic device 201 may not output notification information (e.g., information indicating that the user is in a smombie state) via a display 260 and/or an output device 270, based on identifying that the number of the user's steps is greater than the first threshold value, the absolute value of the first sensing value is greater than the second threshold value, and the absolute value of the second sensing value is less than the third threshold value.

FIG. 9B is a flowchart illustrating a method for operating an electronic device according to an embodiment, wherein the electronic device identifies that a user is exercising while wearing the electronic device on the arm.

Referring to FIG. 9B, according to an embodiment, in operation 911, an electronic device 201 (e.g., the electronic device 201 in FIG. 2B) may identify that the number of a user's steps, identified via a sensor 276 (e.g., the sensor 276 in FIG. 2B), is greater than a first threshold. When it is identified that the number of the user's steps is greater than the first threshold, the electronic device 201 may determine that the user is walking.

According to an embodiment, in operation 913, the electronic device 201 may identify that an angular change of the electronic device 201 is greater than a second threshold value. According to an embodiment, the electronic device 201 may identify, via the sensor 276 (e.g., the sensor 276 in FIG. 2B), a first sensing value indicating the angular change of the electronic device 201. For example, the first sensing value may include pitch data.

According to an embodiment, in operation 915, the electronic device 201 may identify that an angular change of the user's head, identified by a wearable electronic device 204 (e.g., the wearable electronic device 204 in FIG. 2B), is less than a third threshold. According to an embodiment, the wearable electronic device 204 may identify, via a sensor 277 (e.g., the sensor 277 in FIG. 2C), a second sensing value indicating the angular change of the user's head 210. According to an embodiment, the electronic device 201 may receive the second sensing value via a communication module 290 (e.g., the communication module 290 in FIG. 2B). According to an embodiment, when it is identified that the angular change of the user's head is less than the third threshold value, the electronic device 201 may identify that the user is looking straight ahead.

According to an embodiment, in operation 917, when the number of steps is identified to be greater than the first threshold, when the angular change of the electronic device 201 is identified to be greater than the second threshold, and when the angular change of the user's head is identified to be less than the third threshold, the electronic device 201 may identify that the user is exercising while wearing the electronic device 201 on the forearm (or, arm) by using an arm band. In some embodiments, the electronic device 201 may identify that the user is exercising while holding the electronic device 201 in his/her hand.

FIG. 9C is a graph showing a sensing value indicating an angular change of an electronic device and a sensing value indicating an angular change of a user's head, while the user is wearing the electronic device on the arm, according to an embodiment.

According to an embodiment, the horizontal axis may represent the time at which the sensing values are measured. According to an embodiment, the vertical axis may represent the angle.

According to an embodiment, an electronic device 201 (e.g., the electronic device 201 in FIG. 2B) may identify, via a sensor 276 (e.g., the sensor 276 in FIG. 2B), a sensing value 960 representing the angular change of the electronic device 201 relative to the horizontal. According to an embodiment, the sensing value 960 may represent pitch data.

According to an embodiment, the electronic device 201 may identify the number of a user's steps via the sensor 276.

According to an embodiment, a wearable electronic device 204 (e.g., the wearable electronic device 204 in FIG. 2B) may identify a sensing value 950 indicating the angular change of the user's head. According to an embodiment, the sensing value 950 may represent pitch data. According to an embodiment, the wearable electronic device 204 may transmit the sensing value 950 to the electronic device 201.

According to an embodiment, the electronic device 201 may identify that the absolute value of the sensing value 960, which indicates the angular change of the electronic device 201, is greater than a threshold value (e.g., 30 degrees).

According to an embodiment, the electronic device 201 may identify that the number of the user's steps is greater than a threshold value.

According to an embodiment, the electronic device 201 may identify that the absolute value of the sensing value 950 is less than a threshold value (e.g., 30 degrees). According to an embodiment, the threshold value may refer to a threshold value adjusted based on a criterion for a change in the tilt angle of the user's head, established by calibration.

According to an embodiment, when the number of the user's steps is identified to be greater than the threshold value, when the absolute value of the sensing value 960 is identified to be greater than the threshold value (e.g., 30 degrees), and when the absolute value of the sensing value 950 is identified to be less than the threshold value (e.g., 30 degrees), the electronic device 201 may identify that the user is exercising (e.g., walking) while wearing the electronic device 201 on the arm (or, forearm) 211 by using an armband. In some embodiments, the electronic device 201 may identify that the user is exercising while holding the electronic device 201 in his/her hand. According to an embodiment, the electronic device 201 may not output notification information (e.g., information indicating that the user is in a smombie state) via a display 260 and/or an output device 270, based on identifying that the number of the user's steps is greater than a first threshold value, the absolute value of a first sensing value is greater than a second threshold value, and the absolute value of a second sensing value is less than a third threshold value.

An electronic device (101 in FIG. 1 or 201 in FIG. 2B) according to an embodiment may include memory (130 in FIG. 1 or 230 in FIG. 2B), a communication module (190 in FIG. 1 or 290 in FIG. 2B), a sensor (176 in FIG. 1 or 276 in FIG. 2B), an output device (160 in FIG. 1, 155 in FIG. 1, or 260 in FIG. 2B), and at least one processor (120 in FIG. 1 or 220 in FIG. 2B).

In the electronic device 101 or 201 according to an embodiment, the memory 130 or 230 may store instructions that, when executed by the at least one processor 120 or 220, cause the electronic device to perform calibration for sensing a change in a tilt angle of the head of a user wearing a wearable electronic device (102 in FIG. 1, 104 in FIG. 1, 204 in FIG. 2B, or 204-1 in FIG. 2B).

In the electronic device 101 or 201 according to an embodiment, the memory 130 or 230 may store instructions that, when executed by the at least one processor 120 or 220, cause the electronic device to identify the number of the user's steps and a first sensing value indicating an angular change of the electronic device via the sensor 176 or 276 after performing the calibration.

In the electronic device 101 or 201 according to an embodiment, the memory 130 or 230 may store instructions that, when executed by the at least one processor 120 or 220, cause the electronic device to receive, via the communication module 190 or 290, a second sensing value indicating the change in the tilt angle of the head of the user identified by the wearable electronic device.

In the electronic device 101 or 201 according to an embodiment, the memory 130 or 230 may store instructions that, when executed by the at least one processor 120 or 220, cause the electronic device to output notification information via the output device 160, 155, or 260 when the number of the user's steps, the first sensing value, and the second sensing value satisfy specified conditions.

In the electronic device 101 or 201 according to an embodiment, the memory 130 or 230 may store instructions that, when executed by the at least one processor 120 or 220, cause the electronic device to transmit information indicating the start of performing calibration to the wearable electronic device 102, 104, 204, or 204-1 via the communication module 190 or 290.

In the electronic device 101 or 201 according to an embodiment, the memory may store instructions that, when executed by the at least one processor 120 or 220, cause the electronic device to output notification information, which causes the head of the user wearing the wearable electronic device 102, 104, 204, or 204-1 to remain in a specified posture for a predetermined time, via the output device 160, 155, or 260 based on the information indicating the start of performing the calibration.

In the electronic device 101 or 201 according to an embodiment, the memory 130 or 230 may store instructions that, when executed by the at least one processor 120 or 220, cause the electronic device to receive a third sensing value, sensed based on the information indicating the start of performing the calibration, from the wearable electronic device 102, 104, or 204 via the communication module 190 or 290.

In the electronic device 101 or 201 according to an embodiment, the memory 130 or 230 may store instructions that, when executed by the at least one processor 120 or 220, cause the electronic device to receive multiple sensing values, sensed when the user's head is in multiple postures different from the specified posture, from the wearable electronic device via the communication module 190 or 290.

In the electronic device 101 or 201 according to an embodiment, the memory 130 or 230 may store instructions that, when executed by the at least one processor 120 or 220, cause the electronic device to perform, based on the third sensing value and the multiple sensing values, calibration for sensing a change in the tilt angle of the user's head relative to the third sensing value.

In the electronic device 101 or 201 according to an embodiment, the specified posture may include a posture in which the user is looking straight ahead without movement of the user's head.

In the electronic device 101 or 201 according to an embodiment, the multiple postures may include a posture in which the user's head is maximally tilted downward and a posture in which the user's head is maximally tilted upward.

In the electronic device 101 or 201 according to an embodiment, the memory 130 or 230 may store instructions that, when executed by the at least one processor 120 or 220, cause the electronic device to identify that the number of the user's steps, the first sensing value, and the second sensing value satisfy the specified conditions when the number of steps is identified to be greater than a first threshold value, when the absolute value of the first sensing value is identified to be greater than a second threshold value, and when the absolute value of the second sensing value is identified to be greater than a third threshold value obtained through the calibration.

In the electronic device 101 or 201 according to an embodiment, the memory 130 or 230 may store instructions that, when executed by the at least one processor 120 or 220, cause the electronic device to obtain the third threshold value by converting body frame coordinate axes corresponding to coordinate axes of the user's head to navigation frame coordinate axes corresponding to reference coordinate axes.

The electronic device 101 or 201 according to an embodiment may include a display 160 or 260.

In the electronic device 101 or 201 according to an embodiment, the memory 130 or 230 may store instructions that, when executed by the at least one processor 120 or 220, cause the electronic device to output the notification information via the output device 160, 155, or 260 when the display 160 or 260 is turned on.

In the electronic device 101 or 201 according to an embodiment, the second sensing value may include pitch data.

In the electronic device 101 or 201 according to an embodiment, the memory 130 or 230 may store instructions that, when executed by the at least one processor (120 in FIG. 1 or 220 in FIG. 2B), cause the electronic device to identify that the electronic device is worn on the user's arm, when the number of steps and the first sensing value satisfy the specified conditions, and when the second sensing value does not satisfy the specified conditions.

In the electronic device 101 or 201 according to an embodiment, the third sensing value may include at least one of roll data or pitch data sensed in the specified posture.

In the electronic device 101 or 201 according to an embodiment, the multiple sensing values may include at least one of roll data, pitch data, or yaw data sensed in the multiple postures.

In the electronic device 101 or 201 according to an embodiment, the notification information may include information indicating that the user is in a smombie state.

A method for operating an electronic device 101 or 201, according to an embodiment, may include an operation of performing calibration for sensing a change in the tilt angle of the head of a user wearing a wearable electronic device 102, 104, 204, or 204-1.

The method for operating the electronic device 101 or 201, according to an embodiment, may include an operation of identifying the number of the user's steps and a first sensing value indicating an angular change of the electronic device via a sensor 176 or 276 included in the electronic device 101 or 201 after performing the calibration.

The method for operating the electronic device 101 or 201, according to an embodiment, may include an operation of receiving, via a communication module 190 or 290 included in the electronic device 101 or 201, a second sensing value indicating the change in the tilt angle of the head of the user identified by the wearable electronic device 102, 104, 204, or 204-1.

The method for operating the electronic device 101 or 201, according to an embodiment, may include an operation of outputting notification information via an output device 160, 155, or 260 included in the electronic device when the number of the user's steps, the first sensing value, and the second sensing value satisfy specified conditions.

The method for operating the electronic device 101 or 201, according to an embodiment, may include an operation of transmitting information indicating the start of performing the calibration to the wearable electronic device 102, 104, 204, or 204-1 via the communication module.

The method for operating the electronic device 101 or 201, according to an embodiment, may include an operation of outputting notification information, which causes the head of the user wearing the wearable electronic device to remain in a specified posture for a predetermined time, via the output device 160, 155, or 260 based on the information indicating the start of performing the calibration.

The method for operating the electronic device 101 or 201, according to an embodiment, may include an operation of receiving a third sensing value, sensed based on the information indicating the start of performing the calibration, from the wearable electronic device via the communication module.

The method for operating the electronic device 101 or 201, according to an embodiment, may include an operation of receiving multiple sensing values, sensed when the user's head is in multiple postures different from the specified posture, from the wearable electronic device 102, 104, 204, or 204-1 via the communication module 190 or 290.

The method for operating the electronic device 101 or 201, according to an embodiment, may include an operation of performing, based on the third sensing value and the multiple sensing values, calibration for sensing a change in the tilt angle of the user's head relative to the third sensing value.

In the method for operating the electronic device 101 or 201, according to an embodiment, the specified posture may include a posture in which the user is looking straight ahead without movement of the user's head.

In a method for operating the electronic device 101 or 201, according to an embodiment, the multiple postures may include a posture in which the user's head is maximally tilted downward and a posture in which the user's head is maximally tilted upward.

The method for operating the electronic device 101 or 201, according to an embodiment, may include an operation of identifying that the number of the user's steps, the first sensing value, and the second sensing value satisfy the specified conditions, when the number of steps is identified to be greater than a first threshold value, when the absolute value of the first sensing value is identified to be greater than a second threshold value, and when the absolute value of the second sensing value is identified to be greater than a third threshold value obtained through the calibration.

The method for operating the electronic device 101 or 201, according to an embodiment, may include an operation of obtaining the third threshold value by converting body frame coordinate axes corresponding to coordinate axes of the user's head to navigation frame coordinate axes corresponding to reference coordinate axes.

In the method for operating the electronic device 101 or 201, according to an embodiment, the electronic device may include a display.

The method for operating the electronic device 101 or 201, according to an embodiment, may include an operation of identifying whether a screen of the display is turned on, based on identifying that the number of the user's steps, the first sensing value, and the second sensing value satisfy the specified conditions.

The method for operating the electronic device 101 or 201, according to an embodiment, may include an operation of outputting the notification information, based on identifying that the screen of the display 160 or 260 is turned on.

In the method for operating the electronic device 101 or 201, according to an embodiment, the second sensing value may include pitch data.

The method for operating the electronic device 101 or 201, according to an embodiment, may include an operation of identifying that the electronic device is worn on the user's forearm, when the first sensing value and the number of steps satisfy the specified conditions and when the second sensing value does not satisfy the specified conditions.

In a method for operating the electronic device 101 or 201, according to an embodiment, the notification information may include information indicating that the user is in a smombie state.

A storage medium storing computer-readable instructions, according to an embodiment may store one or more instructions which, wherein, when executed by at least one processor (120 in FIG. 1 or 220 in FIG. 2B) of an electronic device (101 in FIG. 1 or 201 in FIG. 2B), the instructions cause the electronic device to perform at least one operation, wherein the at least one operation includes an operation of performing calibration for sensing a change in the tilt angle of the head of a user wearing a wearable electronic device 102, 104, 204, or 204-1.

In the storage medium storing computer-readable instructions according to an embodiment, the instructions, when executed by the at least one processor (120 in FIG. 1 or 220 in FIG. 2B) of the electronic device 101 or 201, may cause the electronic device to perform at least one operation, wherein the at least one operation includes an operation of identifying the number of the user's steps and a first sensing value indicating an angular change of the electronic device via a sensor 176 or 276 included in the electronic device 101 or 201 after performing the calibration.

In the storage medium storing computer-readable instructions according to an embodiment, the instructions, when executed by the at least one processor 120 or 220 of the electronic device 101 or 201, may cause the electronic device to perform at least one operation, wherein the at least one operation includes an operation of receiving, via a communication module 190 or 290 included In the electronic device 101 or 201, a second sensing value the change in the tilt angle of the head of the user identified by the wearable electronic device 102, 104, 204, or 204-1.

In the storage medium storing computer-readable instructions according to an embodiment, the instructions may, when executed by the at least one processor 120 or 220 of the electronic device 101 or 201, cause the electronic device to perform at least one operation, wherein the at least one operation includes an operation outputting notification information via an output device 160, 155, or 260 included in the electronic device when the number of the user's steps, the first sensing value, and the second sensing value satisfy specified conditions.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101, 201). For example, a processor (e.g., the processor 120, 220, 221) of the machine (e.g., the electronic device 101, 201, 204, 204-1) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
communication circuitry;
a sensor;
an output device;
at least one processor; and
memory storing instructions, wherein the instructions, when executed by the at least one processor individually or collectively, cause the electronic device to:
perform calibration for sensing a change in a tilt angle of a head of a user wearing a wearable electronic device;
identify a number of steps of the user and a first sensing value indicating an angular change of the electronic device via the sensor after performing the calibration;
receive, via the communication circuitry, a second sensing value indicating the change in the tilt angle of the head of the user identified by the wearable electronic device; and
output notification information, via the output device, based on the number of steps of the user, the first sensing value, and the second sensing value satisfying specified conditions.

2. The electronic device of claim 1, wherein the instructions, when executed by the at least one processor individually or collectively, cause the electronic device to:
transmit, via the communication circuitry, information indicating a start of performing calibration to the wearable electronic device;
output notification information, via the output device instructing the user to remain in a specified posture for a predetermined time based on the information indicating the start of performing the calibration;
receive, via the communication circuitry, a third sensing value from the wearable electronic device sensed based on the information indicating the start of performing the calibration;
receive, via the communication circuitry, multiple sensing values from the wearable electronic device sensed when the head of the user is in multiple postures different from the specified posture; and
perform the calibration relative to the third sensing value, based on the third sensing value and the multiple sensing values.

3. The electronic device of claim 2, wherein the specified posture comprises a posture in which the user is looking straight ahead without movement of the head of the user, and
wherein the multiple postures comprise a posture in which the head of the user is maximally tilted downward and a posture in which the head of the user is maximally tilted upward.

4. The electronic device of claim 1, wherein the instructions, when executed by the at least one processor individually or collectively, cause the electronic device to, identify that the number of steps of the user, the first sensing value, and the second sensing value satisfy the specified conditions based on the number of steps being greater than a first threshold value, an absolute value of the first sensing value being greater than a second threshold value, and an absolute value of the second sensing value being greater than a third threshold value obtained through the calibration.

5. The electronic device of claim 4, wherein the instructions, when executed by the at least one processor individually or collectively, cause the electronic device to obtain the third threshold value by converting body frame coordinate axes corresponding to coordinate axes of the head of the user to navigation frame coordinate axes corresponding to reference coordinate axes.

6. The electronic device of claim 1, further comprising a display,
wherein the instructions, when executed by the at least one processor individually or collectively, cause the electronic device to output the notification information via the output device based on a screen of the display being turned on.

7. The electronic device of claim 1, wherein the second sensing value comprises pitch data.

8. The electronic device of claim 1, wherein the instructions, when executed by the at least one processor individually or collectively, cause the electronic device to identify that the electronic device is worn on an arm of the user based on the number of steps and the first sensing value satisfying the specified conditions and the second sensing value not satisfying the specified conditions.

9. The electronic device of claim 2, wherein the third sensing value comprises at least one of roll data or pitch data sensed in the specified posture, and
wherein the multiple sensing values comprise at least one of roll data, pitch data, or yaw data sensed in the multiple postures.

10. The electronic device of claim 1, wherein the notification information comprises information indicating that the user is in a smombie state, the smombie state being a state in which the user is walking with the head tilted downward to view the electronic device.

11. A method comprising:
performing calibration for sensing a change in a tilt angle of a head of a user wearing a wearable electronic device;
identifying a number of steps of the user and a first sensing value indicating an angular change of an electronic device via a sensor of the electronic device after the performing the calibration;
receiving, via a communication circuitry of the electronic device, a second sensing value indicating the change in the tilt angle of the head of the user identified by the wearable electronic device; and
outputting notification information via an output device of the electronic device based on the number of steps of the user, the first sensing value, and the second sensing value satisfying specified conditions.

12. The method of claim 11, further comprising:
transmitting, via the communication circuitry, information indicating a start of performing calibration to the wearable electronic device;
outputting notification information, via the output device instructing the user wearing the wearable electronic device to remain in a specified posture for a predetermined time based on the information indicating the start of performing the calibration;
receiving, via the communication circuitry, a third sensing value from the wearable electronic device sensed based on the information indicating the start of performing the calibration;
receiving, via the communication circuitry, multiple sensing values from the wearable electronic device sensed when the head of the user is in multiple postures different from the specified posture; and
performing, based on the third sensing value and the multiple sensing values, calibration for sensing the change in the tilt angle of the head of the user relative to the third sensing value.

13. The method of claim 12, wherein the specified posture comprises a posture in which the user is looking straight ahead without movement of the head of the user, and
wherein the multiple postures comprise a posture in which the head of the user is maximally tilted downward and a posture in which the head of the user is maximally tilted upward.

14. The method of claim 11, further comprising
identifying that the number of steps of the user, the first sensing value, and the second sensing value satisfy the specified conditions based on the number of steps being greater than a first threshold value, an absolute value of the first sensing value being greater than a second threshold value, and an absolute value of the second sensing value being greater than a third threshold value obtained through the calibration.

15. The method of claim 14, further comprising:
obtaining the third threshold value by converting body frame coordinate axes corresponding to coordinate axes of the head of the user to navigation frame coordinate axes corresponding to reference coordinate axes.

16. The method of claim 11, further comprising:
outputting the notification information via the output device based on a screen of a display of the electronic device being turned on.

17. The method of claim 11, wherein the second sensing value comprises pitch data.

18. The method claim 11, further comprising:
identifying that the electronic device is worn on an arm of the user based on the number of steps and the first sensing value satisfying the specified conditions and the second sensing value not satisfying the specified conditions.

19. The method of claim 12, wherein the third sensing value comprises at least one of roll data or pitch data sensed in the specified posture, and
wherein the multiple sensing values comprise at least one of roll data, pitch data, or yaw data sensed in the multiple postures.

20. A non-transitory storage medium storing computer-readable instructions, wherein the instructions, when executed by at least one processor of an electronic device, individually or collectively, cause the electronic device to:
perform calibration for sensing a change in a tilt angle of the head of a user wearing a wearable electronic device;
identify a number of steps of the user and a first sensing value indicating an angular change of the electronic device via a sensor of the electronic device after performing the calibration;
receive, via a communication circuitry of the electronic device, a second sensing value indicating the change in the tilt angle of the head of the user identified by the wearable electronic device; and
output notification information via an output device of the electronic device based on the number of steps of the user, the first sensing value, and the second sensing value satisfying specified conditions.
